(19) United States
(12) Patent Application Publication
(10) Pub. No.: US 2025/0220775 A1
(43) Pub. Date: Jul. 3, 2025

(54) SYSTEMS, METHODS, AND DEVICES FOR PROVIDING LOW ENERGY DEFROSTING AND HEATING TO MULTIPLE SURFACES

(71) Applicant: Betterfrost Technologies Inc., Oakville (CA)

(72) Inventors: Sameh M. I. Saad, Stoney Creek (CA); Ahmed Sheir, Brampton (CA); Derrick Redding, Ann Arbor, MI (US)

(21) Appl. No.: 18/985,648

(22) Filed: Dec. 18, 2024

Related U.S. Application Data
(60) Provisional application No. 63/615,956, filed on Dec. 29, 2023.

(51) Int. Cl. H05B 1/02; F25B 47/02; H05B 3/84

(52) U.S. Cl. CPC H05B 1/02; F25B 47/02; H05B 3/84

(57) ABSTRACT

Systems, methods, and devices for detecting and removing frozen accumulation from a plurality of surfaces is provided. The system comprises: a plurality of conductive elements connected to the plurality of surfaces; a powering unit conductively connected to each of the plurality of conductive elements, the powering unit configured to heat each of the plurality of conductive elements; and a controller unit connected to the powering unit, the controller unit configured to activate the powering unit for selective heating of each of the plurality of conductive elements. The system further comprises activating the controller unit automatically based on detection of an ambient condition on the each of the plurality of conductive elements, wherein the ambient condition includes ice, frost, fog, moisture, or a temperature threshold.

### TECHNICAL FIELD

The following relates generally to systems, methods, and devices for temperature control including surface deicing and defogging, and more particularly to systems, methods, and devices for low-energy defrosting and heating to multiple surfaces.

### INTRODUCTION

Various methods and systems are used for providing electrothermal power for surface heating, defrosting, deicing, and defogging, for surfaces such as windshields or other surfaces of vehicles and refrigeration equipment such as coils. The vehicles may include automobiles, electric vehicles, locomotives, aircraft, buses, and heavy goods vehicles.

In these systems and methods, surfaces are often equipped with built-in heating elements made by means of transparent or non-transparent electric conductive coatings. These coatings are activated and generate heat when an electrical current is applied. Not limited to coatings, the heating features can also be constructed using other conductive resources like thin wiring. Integration of the conductive coatings into the vehicle's own electrical infrastructure is achieved by means of busbars. The allocation and management of electrical flow to these busbars and heating components are overseen by switches or specialized processing units.

The electrothermal surface defrosting and defogging systems operate on the principle of resistive heating encountered by conductive coatings or films placed at various surfaces such as windshields and side mirrors of vehicles, or refrigerator coils. The inherent resistivity of conductive coatings or films ensures that when the passing electric current is applied to the conductive coatings, the resistance of the coating causes resistive heating, which is passed on to the surfaces. Common materials used in conductive coatings include Fluorine-doped Tin Oxide (FTO) and Indium Tin Oxide (ITO) to elements like carbon nanotubes and silver, each selected for their unique blend of resistive and conductive traits.

Due to the inherent nature of resistive heating, a significant amount of electric current is needed to produce enough heat to defrost surfaces. This conversion of electricity may not be efficient, and some energy may inevitably be lost. Further, in certain local or environmental conditions, especially during extreme cold or high humidity, defrosting systems might need to operate continuously or frequently. This persistent use leads to a constant drain on the electrical power source.

In vehicles, using an electric defrosting system for the windshield and other windows can strain the vehicle's battery and alternator, especially if other high-consumption systems (like heating, air conditioning, or entertainment systems) are also in use. This is even more pronounced in electric vehicles where battery life and driving range are paramount. To ensure safety, especially in vehicles, it is crucial that the defrosting systems work quickly. However, rapid heating uses more power, creating a trade-off between safety and efficiency.

In refrigeration, where defrost cycles are essential to maintain efficiency and prevent ice buildup, regular defrost cycles can lead to significant energy use, increasing operational costs and reducing the efficiency of the refrigeration system. Further, in some cases, the surrounding insulation or design of the defrosting system isn't optimized, leading to heat loss and, consequently, the system drawing more power to compensate.

Considering the challenges of climate change, there is an inclination among industries and end-users to curtail energy consumption and embrace methodologies with enhanced energy efficiency. As documented by the International Institute for Refrigeration, refrigeration processes account for approximately 17% of worldwide energy utilization, with defrosting operations consuming about a quarter (25%) of this designated fraction.

In electrical vehicles, including both automobiles and trucks, the process of defrosting a windshield necessitates a significant energy use, often exceeding 4 kWh for a singular defrosting action, especially when the range of the electric vehicle (EV) is inherently limited under frigid conditions. The primary energy source for the defrosting and defogging functions in such EVs predominantly originates from the vehicle's high-voltage battery assembly. This battery assembly also concurrently serves as the chief power supply for the electric motor systems, which impacts the vehicle's operative range. Consequently, any power allocation from the battery for defrosting and defogging operations inherently diminishes the available driving range. An empirical examination conducted on electric vehicle fleets by Geotab™ disclosed that at temperatures approximating −20° C., the actual vehicular driving range reduces by 41% relative to the declared range, attributing this to cabin thermal management including defrosting and defogging. The implications from this analysis underscore that with each decrement of 10° C. from an ambient 24° C., the actual driving range of an EV diminishes by approximately 20%.

Notably, in electric vehicles, there is a need for surface heating across multiple components beyond just the windshield. This includes side windows, roof glass, the rear window, ADAS surfaces (Advanced Driver-Assistance Systems e.g., cameras, LIDAR), LED headlamps, and the outside heat exchanger used with heat pump systems. Similar to the front windshield, the side windows, moonroof/sunroof, and rear windows also use defrosting and defogging in cold weather to improve the visibility of the surroundings. The front side windows are typically heated via hot air from the HVAC system via the side air ducts. Contemporary defrosting methodologies necessitate a singular solution application or set of equipment for each individual surface, primarily due to the high energy consumption characteristic of existing techniques.

Further, in electric vehicles, regenerative braking provides an efficient method to capture kinetic energy and return energy to the battery. However, brake calipers are less frequently used, and in cold temperatures, brake calipers may freeze with ice making the brake system inoperable. Therefore, heating the braking system is also used as a safety precaution to ensure that brakes operate properly in EVs, especially in cold weather.

Furthermore, as heat pumps become increasingly prevalent for heating electric vehicles in colder climates, they often utilize an Outside Heat Exchanger (OHX) to extract heat from the surrounding environment into the refrigerant. However, starting from slightly above freezing points, like +2° C. and colder, the OHX begins to gradually accumulate frost on its fins and tubes. This frost accumulation hinders air flow and diminishes the efficiency of the heat exchanger. Present solutions to defrost the OHX involve energy-intensive defrost cycles that warm up the cooling agent and generate heat, allowing for the entire OHX to be heated and the frost to be eliminated.

Similarly, multiple surfaces of aircraft may use surface heating for defrosting and defogging, such as the wings, windshield, tail, and horizontal stabilizers.

Multiple surfaces may also use heating in refrigeration systems. In large refrigeration setups, various heat exchangers or evaporator coils might be integrated into the refrigeration systems. For instance, large cold storage facilities or commercial refrigeration/freezer compartments often employ numerous heat exchangers operating concurrently to cover vast spaces. Every single evaporator heat exchanger is prone to accumulating frost and demands significant energy for defrosting.

Electric defrosting and defogging systems, especially when used across various surfaces, can draw a significant amount of power. This can strain the energy source, leading to quicker depletion of batteries in electric vehicles. Further, managing and controlling multiple electric heating elements adds complexity to the system, which can introduce potential points of failure.

Accordingly, systems, methods, and devices are desired that overcome one or more disadvantages associated with existing surface deicing systems, particularly towards providing low-energy defrosting and heating to multiple surfaces.

### SUMMARY

A system for temperature control including detecting and removing frozen accumulation and defogging from a plurality of surfaces is provided. The system comprises a plurality of conductive elements connected to the plurality of surfaces; a powering unit conductively connected to each of the plurality of conductive elements, the powering unit configured to heat each of the plurality of conductive elements; and a controller unit connected to the powering unit, the controller unit configured to activate the powering unit for selective heating of each of the plurality of conductive elements, wherein a plurality of conductive elements are controlled by a single controller unit for low energy defrosting and defogging.

In an embodiment, the plurality of conductive elements comprises of a plurality of material properties, the plurality of material properties including size, compositional material, electrical conductivity, electrical resistance, heat coefficient, and structural dimension.

In an embodiment, the controller unit is activated automatically based on detection of an ambient condition on the each of the plurality of conductive elements, wherein the ambient condition includes at least one of: ice, frost, fog, moisture, a relative humidity, and a temperature threshold.

In an embodiment, the system further includes a power queue unit, the power queue unit configured to identify the selective heating of each of the plurality of conductive elements based on the plurality of material properties and the ambient condition of each of the plurality of conductive elements.

In an embodiment, the plurality of conductive elements are connected to a plurality of corresponding sensors to detect ambient condition for the each of the plurality of conductive elements.

In an embodiment, the controller unit is connected to a sensor unit, wherein the sensor unit is configured to collect the detect ambient condition from the plurality of corresponding sensors.

In an embodiment, the powering unit includes a plurality of power sources corresponding to the each of the plurality of conductive elements.

A method for detecting and removing frozen accumulation from a plurality of surfaces is provided. The method comprises: sending a sensor data from a plurality of conductive elements to a powering unit; determining, by a power matrix, a heating element in the power matrix required to be activated and determining an energy amount needed the heating element, wherein the heating element is connected to a respective conductive element designated for heating; receiving a start signal by a controller to activate a low-energy multiple-surface heating system, wherein the plurality of conductive elements are connected to a plurality of surfaces, and a powering unit is conductively connected to each of the plurality of conductive elements; determining, by a power queue, management and distribution of power among the plurality of conductive elements designated for heating and a sequence of supplying power to the heating element for optimum time utilization and rapid deicing and defrosting; and activating a power converter based on the power queue, wherein the power queue is configured to activate power delivery to the conductive elements designated for heating.

In an embodiment, the plurality of conductive elements comprises of a plurality of material properties for adjusting a resistance according to a surface, the plurality of material properties including size, compositional material, electrical conductivity, electrical resistance, heat coefficient, and structural dimension.

In an embodiment, the powering unit is activated automatically based on detection of an ambient condition on the each of the plurality of conductive elements, wherein the ambient condition includes at least one of: ice, frost, fog, moisture, a relative humidity, and a temperature threshold.

In an embodiment, the method further comprises identifying the selective heating of each of the plurality of conductive elements based on the plurality of material properties and the ambient condition of each of the plurality of conductive elements.

In an embodiment, the plurality of conductive elements are connected to a plurality of corresponding sensors to detect ambient condition for the each of the plurality of conductive elements.

In an embodiment, the powering unit is connected to a sensor unit, wherein the sensor unit is configured to collect the detect ambient condition from the plurality of corresponding sensors.

In an embodiment, the powering unit includes a plurality of power sources corresponding to the each of the plurality of conductive elements.

A device for detecting and removing frozen accumulation from a plurality of surfaces is provided. The device comprising:
a processing module configured to activate the low-energy multiple-surface heating function on receiving the start signal, wherein a plurality of conductive elements to the plurality of surfaces, and a powering unit is conductively connected to each of the plurality of conductive elements; a power matrix module configured to manage the power matrix and determining which heating element in this matrix needs to be activated, wherein the power matrix includes conductive elements designated for heating; a sensor data collection module configured to receive sending the sensor data from the plurality of conductive elements to the powering unit; a power queue module configured to determine the power queue to manage the distribution of power among the conductive elements designated for heating; and a power converter module configured to activate the power converter based on the power queue, wherein the power queue is configured to activate power delivery to the conductive elements designated for heating.

In an embodiment, the plurality of conductive elements comprises of a plurality of material properties, the plurality of material properties including size, compositional material, electrical conductivity, electrical resistance, heat coefficient, and structural dimension.

In an embodiment, the device is activated automatically based on detection of an ambient condition on the each of the plurality of conductive elements, wherein the ambient condition includes at least one of ice, frost, fog, moisture, a relative humidity, and a temperature threshold.

In an embodiment, the plurality of conductive elements are connected to a plurality of corresponding sensors to detect ambient condition for the each of the plurality of conductive elements.

In an embodiment, the sensor data collection module is connected to a sensor unit, wherein the sensor unit is configured to collect the detect ambient condition from the plurality of corresponding sensors.

In an embodiment, the power converter module is connected to a plurality of power sources corresponding to the each of the plurality of conductive elements.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of systems, methods, and devices of the present specification. In the drawings:

FIG. 1 shows a block diagram illustrating a system for deicing and defogging the exposed surfaces.

FIG. 2 shows a schematic diagram of an electronic 200, according to an embodiment.

FIG. 3 shows a system diagram of a low-energy multiple-surface heating system 300, according to an embodiment.

FIG. 4 shows a flow chart of a method 400 for low-energy multiple-surface heating, according to an embodiment.

FIG. 5 is a block diagram of a controller 500 for a multi-surface defogging and defrosting, according to an embodiment.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

One or more systems described herein may be implemented in computer programs executing on programmable computers, each comprising at least one processor, a data storage system (including volatile and non-volatile memory and/or storage elements), at least one input device, and at least one output device. For example, and without limitation, the programmable computer may be a programmable logic unit, a mainframe computer, server, and personal computer, cloud based program or system, laptop, personal data assistance, cellular telephone, smartphone, or tablet device.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device readable by a general or special purpose programmable computer for configuring and operating the computer when the storage media or device is read by the computer to perform the procedures described herein.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of more than one device or article.

While the present apparatus and processes have been described with reference to particular embodiments, it should be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

In this regard, the scope of the present apparatus and processes is not limited to the specific embodiments disclosed herein. Other variations, modifications, and alternatives are also within the scope of the present apparatus and processes. The appended claims are intended to cover such variations, modifications, and alternatives as fall within their true spirit and scope.

Additionally, the present disclosure is not limited to the described methods, systems, devices, and apparatuses, but includes variations, modifications, and other uses thereof as come within the scope of the appended claims. The detailed description of the embodiments and the drawings are illustrative and not restrictive.

For this application, temperature control including detecting, defogging, and de-icing. De-icing includes melting, at least a section, of the accumulated ice on the exposed surface. Similarly, defogging or demisting includes the elimination or prevention, at least a section, of the fog or mist layer on the glass surface. The operations described for de-icing or defogging include surface heating. The ablated or patterned surfaces described in the present disclosure may be configured to provide surface heating or reduce heat loss through the glass. For this application, detecting and removing frozen accumulation includes detection or removal, at least a section, of the fog or mist layer on the glass or other intended surface.

The following relates generally to systems, methods, and devices for multiple surface deicing and defogging, and more particularly to systems, methods, and devices for providing low-energy defrosting and heating to multiple surfaces.

Electric windshield deicing systems work on the principle of resistive heating, where an electric current is passed through a transparent electro-conductive coating in the windshield glass. The resistive heating is caused due to passage of the electric current, leading to the melting, of at least a section of the ice accumulation on the exterior windshield surface. Electric windshield defogging systems operate on a similar principle, where the transparent electro-conductive coating in the windshield is applied close to the glass layer exposed to the interior of the vehicle. The heat generated due to resistive heating at the inner glass layer controls the glass surface temperature around the dew point and hence defogs the surface.

Low-Emissivity (Low-E) glass, when incorporated into automotive windshields and windows, confers an array of advantageous properties, such as enhanced thermal and energy conservation, thereby minimizing undesired thermal ingress or egress within the vehicular confines. One of the distinguishing characteristics of Low-E glass is the deposition of a minute metal or metal oxide layer that acts as a reflective barrier against thermal radiation and impedes thermal transmission, thus facilitating controlled heat flow into the interior of the automotive. When subjected to solar radiation, surfaces equipped with Low-E glass reflect radiant heat, ensuring a moderated internal environment. Conversely, in colder climates, this glass minimizes the thermal outflow, retaining the interior warmth. Additionally, Low-E glass plays a pivotal role in obstructing harmful ultraviolet (UV) radiations and infrared transmissions, all while preserving visible light transmission, ensuring both vehicular interiors and occupants remain safeguarded against UV-induced damage. Collectively, the incorporation of Low-E glass elevates both thermal modulation and energy thriftiness, consequently diminishing the reliance on auxiliary heating or cooling within the vehicle. Additional features pertaining to UV and infrared reflection render Low-E glass useful in other areas such as the construction of buildings.

The low-emissivity coatings of Low-E Glass are applied using techniques like pyrolytic or hard coat procedures and Magnetron Sputter Vacuum Deposition (MSVD). Common methods adopted for low-emissivity coatings include Pyrolytic layers, Dual Silver MSVD, and Ternary Silver MSVD.

The systems and methods for deicing windshields may leverage pulse electrothermal deicing (PETD). PETD methods may be applied to defrost heat exchangers for refrigeration systems or the OHX in EVs. Smart surface systems for detecting ice and providing rapid deicing may be used on critical surfaces of airplanes, drones, buildings, windmills, and other surfaces that call for defrosting.

The systems and methods for deicing windshields leveraging PETD provide a high heating power density (expressed in W/m\hat{ }2), facilitating expeditious and energy-efficient defrosting mechanisms. PETD-based deicing systems for windshields utilize resistive heating elements or conductive coatings embedded within or attached to the glass. When a pulsed electric current is passed through these elements or coatings, it generates heat due to their inherent resistance. This heat warms the windshield, effectively melting and removing any ice or frost that has formed on its surface.

To defrost a Low-E windshield or glass that has transparent conductive metal coatings inside of the glass lamentation, an electric voltage is applied to this conductive layer. In order to minimize the heat used to remove frost, ice, and fog from a vehicle's glass surface, high power levels of typically 4 KW or more, are applied to this metal layer. This is approximately the minimum electrical power for completely defrosting and defogging the windshield, without supplementing with air defrost or defog. For example, at −20° C., a constant 48V system may defrost using about 2 kW of power.

Therefore, the current electric defrosting and defogging systems have substantial electrical power consumption. In vehicles where conserving energy is important, such as electric vehicles, the significant power draw from these systems may strain the primary energy source, resulting in diminished performance or reduced driving range.

Additionally, the electric systems are inefficient in providing defogging and defrosting to multiple surfaces simultaneously. The challenges include efficiently distributing power among the various surfaces and optimizing electrical controllers for multi-surface operations.

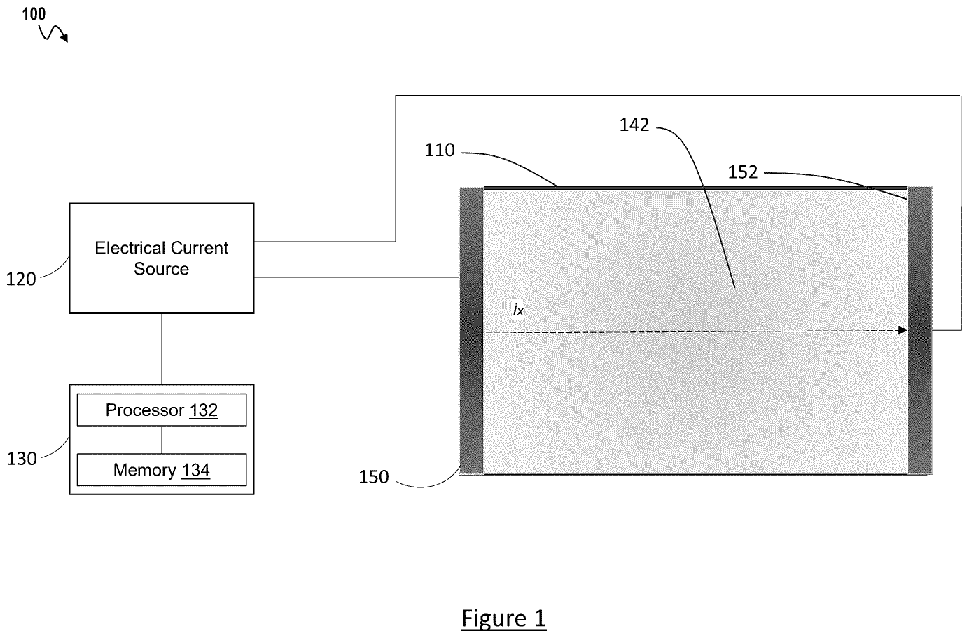

FIG. 1 shows a block diagram illustrating a system 100 for controlling temperature including deicing and defogging the exposed surfaces.

The system is configured to remove ice from the surface 110. The surface 110 may include vehicle windshields, rear vehicle windows, vehicle roof glass, aircraft windshields, and glass or similar material used in buildings.

The system includes an electrical current source 120. The electrical current source 120 may be connected to a vehicle battery.

The electrical current source 120 is further connected to a processing unit 130. The processing unit includes a processor 132 and memory 134.

The surface 110 includes a transparent electro-conductive coating 142. The connectors 150 and 152 create a potential difference leading to the current flow as indicated ix. The electrical current source 120 may provide pulsed electrothermal deicing (PETD) current to the connectors 150 and 152, resulting in the flow of electric current and generation of resistive heating to the surface 110 for de-icing. The electrical current source includes a direct current (DC). Other forms of electric current provided by the electrical current source include alternating current (AC) for conveniently stepping up or reducing the voltage power. The electrical current source includes a plurality of current types, with the application of a direct current (DC) first. The preferred resistance properties in heating track 140 range between 1 ohm and 100 ohms per square.

The system may include an impedance meter (not shown) to provide a capacitance level based on the phase difference between the AC excitation signal provided by the AC excitation source (not shown) and the induced current. The memory 134 may also store de-icing conditions based on the capacitance level or the impedance level corresponding to the detected thickness of the ice accumulation. When the ice accumulation exceeds a threshold thickness, the de-icing condition may be satisfied and the processor 132 may execute instructions to activate the electric current source 120 for providing the electric current to the heating track 140 for deicing. The electric current source 120 may be deactivated when the ice accumulation and thickness fall below the threshold thickness corresponding to the de-icing conditions.

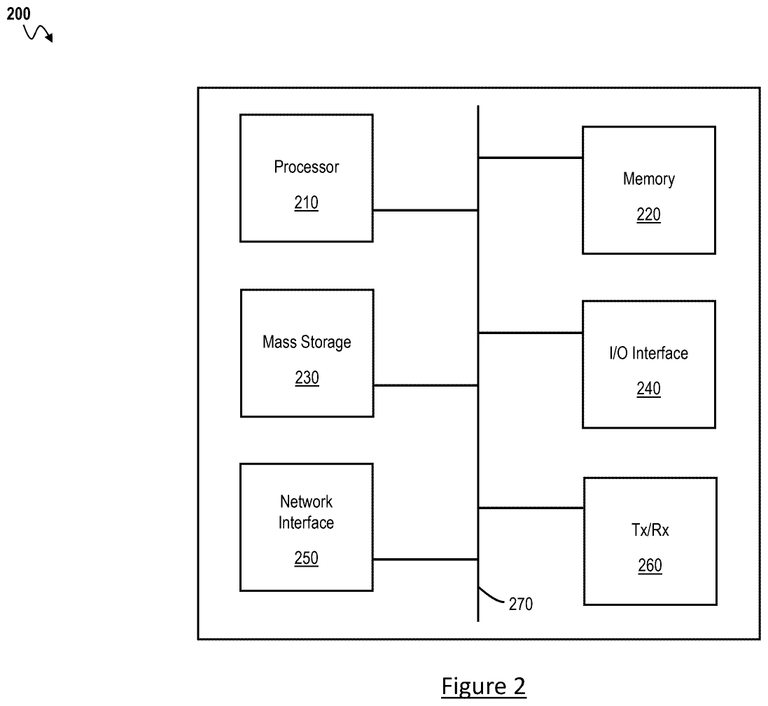

FIG. 2 shows a schematic diagram of an electronic device 200 that may perform any or all of operations of the methods and features explicitly or implicitly described herein, according to an embodiment. For example, a computer equipped with network function may be configured as electronic device 200.

As shown, the device includes a processor 210, such as a Central Processing Unit (CPU) or specialized processors such as a Graphics Processing Unit (GPU) or other such processor unit, memory 220, non-transitory mass storage 230, I/O interface 240, network interface 250, and a transceiver 260, all of which are communicatively coupled via bi-directional bus 270.

According to certain embodiments, any or all of the depicted elements may be utilized, or only a subset of the elements. Further, the device 200 may contain multiple instances of certain elements, such as multiple processors, memories, or transceivers. Also, elements of the hardware device may be directly coupled to other elements without the bi-directional bus.

Additionally or alternatively to a processor and memory, other electronics, such as integrated circuits, may be employed for performing the required logical operations.

The memory 220 may include any type of non-transitory memory such as static random access memory (SRAM), dynamic random access memory (DRAM), synchronous DRAM (SDRAM), read-only memory (ROM), any combination of such, or the like.

The mass storage element 230 may include any type of non-transitory storage device, such as a solid state drive, hard disk drive, a magnetic disk drive, an optical disk drive, USB drive, or any computer program product configured to store data and machine executable program code. According to certain embodiments, the memory 220 or mass storage 230 may have recorded thereon statements and instructions executable by the processor 210 for performing any of the method operations described herein.

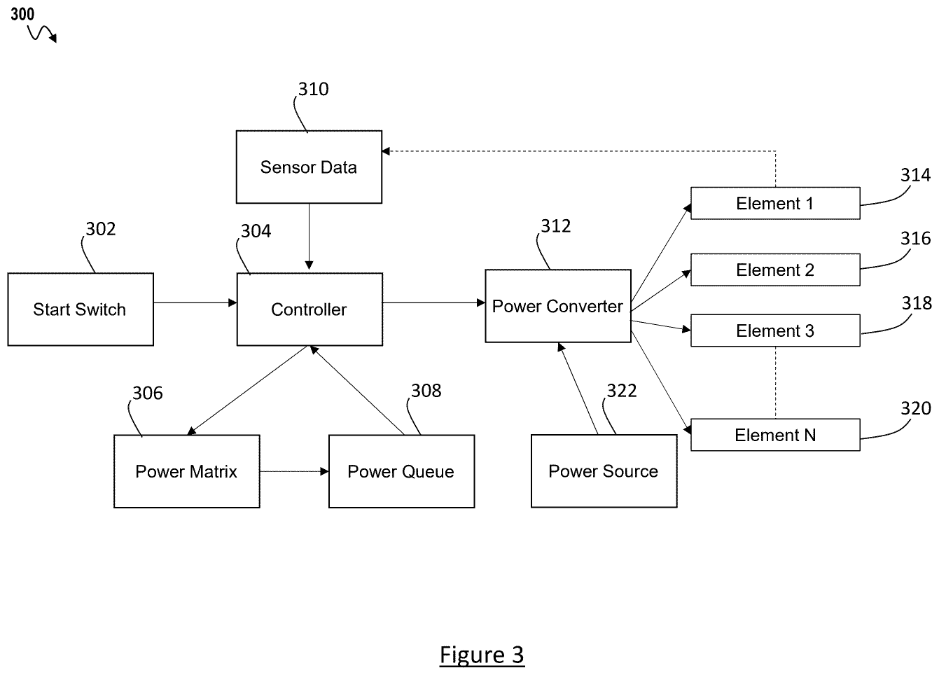

FIG. 3 shows a system diagram of a low-energy multiple-surface heating system 300, according to an embodiment.

The system 300 may be integrated to heat multiple surfaces in passenger vehicles, commercial trucks, aircrafts, ships, trains, or other vehicles. The system may also be integrated to heat multiple surfaces in refrigeration equipment. Examples of the surfaces that may want heating include for defrosting and defogging include, but are not limited to, windshields, glass, roof glass, side windows, rear windows, top windows (sunroof or panoramic roof), ADAS surfaces (cameras, or LiDAR), headlamps, the Outside Heat Exchanger, brakes, evaporator heat exchangers, and others.

Pulsed high-power heating systems are efficient in keeping surfaces clear of moisture such as ice, frost, or fog condensation, while minimizing energy consumption and time duration for running those systems. Another advantage is that pulsed high-power heating systems can provide a thermal barrier that can significantly reduce the heating load inside the cabin. High power includes short bursts or pulses of energy instead of continuous power. In certain embodiments, continuous power supply may be employed in lieu of pulsed power, owing to specific material characteristics or operational constraints.

The low-energy multiple-surface heating system 300 provides pulsed electrical power to multiple surfaces for resistive heating. During the pauses between pulses at one surface, the system 300 directs similar high-power electricity to another surface, thereby providing resistive heating to the other surface. In some embodiments, more than one surface may be activated at the same time. Thus, removing the need for a surface having to wait.

The system 300 includes a timed switch (not shown) in a controller 304, programmed by means of an algorithm to govern the sequence and duration of the pulsed electrical power. Upon activation, the timed switch may direct the first pulse of electrical power to the initial surface. Once this pulse concludes, the timed switch, based on the timed sequence, then redirects the subsequent pulse to the second surface. This sequence persists, with each surface receiving its designated pulse, ensuring every surface is adequately addressed without any continuous electrical supply to any individual surface. This systematic, sequential approach ensures each surface gets an optimal amount of heat for defrosting while maintaining energy efficiency and minimizing potential wear on any single surface.

In an embodiment, by using a timed switching means in an electric vehicle, the pulsed electrical power may be provided to the windshield as the first part of the sequence; thereafter, the pulsed electrical power may be provided to the front side windows as the second part of the sequence; thereafter, the pulsed electrical power may be provided to the rear seat side windows as the third part of the sequence; thereafter, the pulsed electrical power may be provided to the rear window as the fourth part of the sequence; thereafter, the pulsed electrical power may be provided to the ADAS surfaces (e.g., Camera, LiDAR, etc.) as the fifth part of the sequence; thereafter, the pulsed electrical power may be provided to the headlamp surfaces as the sixth part of the sequence; thereafter, the pulsed electrical power may be provided to the brakes as the seventh part of the sequence; and thereafter, the pulsed electrical power may be provided to the outside heat exchanger (Heat Pump System) as eighth part of the sequence.

In an embodiment, when applied to a refrigeration system, the system provides high-power heating and defrosting to multiple heat exchangers by rotating the power to each heat exchanger. Alternatively, each set of pulses may provide a complete defrost/defog process.

Since the low-energy multiple-surface heating system 300 proves pulse power to each of the surfaces requiring defrosting and defogging, the need for continuous power to any one surface is obviated. In an embodiment, system 300 provides short-duration, high-power heating to create longer pauses between heating events.

In contrast, the provision of longer duration and lower power is inefficient for defogging and defrosting as the low power may be inadequate to achieve the desired heat, and longer duration on one surface may not offer proper heating to other surfaces.

The low-energy multiple-surface heating system includes a start switch 302. The start switch 302 operates as the activation point for the low-energy multiple-surface heating system.

In various embodiments, the start switch may be implemented on surfaces, while in other embodiments, surfaces would be started automatically based on the surrounding environmental conditions such as temperature and/or humidity.

In an automobile, the start switch 302 may include a manual or automatic switch such as a dashboard button, or a touchscreen interface allowing the driver to tap on a designated icon to activate the system, or a voice activation interface leveraging voice recognition technologies, or an automatic sensing device to auto-initiate the system when specific conditions are detected, such as a certain drop in temperature, a certain change in relative humidity, or noticeable frost buildup. The automatic initiation is based on the detection condition such as the detection of ice, frost, or fog on the surface or a temperature threshold. The detection condition or threshold could be customized for each heating element.

The start switch 102 is communicatively connected to the controller 104.

The system includes a controller 304. The controller 304 is configured to rotate the supply of pulsed electrical power to heating elements 314, 316, 318, and 320, wherein at least one element is connected to a target surface. The target surface may include the windshield, handles, rear windows, etc. of a vehicle. In an embodiment, a single controller 304 manages and switches the electrical power supply to a plurality of heating elements. Therefore, by not providing a controller for each surface, an overall reduction in parts of the system is achieved, thereby reducing complexity and cost for the vehicle using such a system.

In various embodiments, the heating elements may include at least one of embedded wires, patterned conductive elements, or other conductive elements.

The controller 304 operates as the central processing unit for the low-energy multi-surface heating system 300.

The controller 304 continuously monitors the state of each target surface and corresponding heating element using sensor data 310 and respective element information to determine the real-time needs for heating. The controller 304 is connected to each of the multiple heating elements connected to various surfaces of the vehicle requiring heating for defogging and defrosting.

The controller 304, depending on the sensed condition, is configured to adapt the power pulse frequency and duration to ensure optimal defrosting and defogging without wastage of energy.

The controller 304 may provide energy management service. The controller 304 may adjust energy distribution to ensure the most efficient use of available power, optimizing for energy conservation.

The controller 304, prioritizes the direction of pulsed power to a specific heating element in the plurality of heating elements that uses prioritized frost or fog removal. For example, the user might prioritize the removal of frost from the windscreen before the frost removal from the rear windows. The controller 304 may allow users to manually set preferences, such as specific temperature thresholds for each surface.

The controller 304 provides error detection service. If a malfunction is detected in a surface heating element or any other component, the controller 304 may isolate that section, trigger alerts, or switch to an alternate operation mode to prevent further complications or safety risks.

The controller 304 is configured to, on receiving a start signal from the start switch 302, manage a power matrix 306 (list of all elements) and decide which heating element in this matrix needs to be activated. In an embodiment, the power matrix 306 comprises a hierarchical arrangement or an ordered list of all the heating elements. The power matrix 306 matrix includes a record of each heating element within the system, alongside their respective attributes. The attributes include, but are not limited to, the maximum power per unit, peak power capacity, sensor-derived data, sensor readings, and specific energy requirements pertinent to deicing and defogging functions. In an embodiment, the controller 304, upon receipt of an initiation command via the start switch 302, utilizes this matrix to ascertain and activate the appropriate heating elements based on the current operational needs

The system includes a power queue 308 to effectively manage the distribution of power among various surfaces. The identifiers of the heating elements that need activation are sent to power queue 308. The controller 304 then activates the power converter 312 based on the power queue 308. The power converter 312 provides electrical power to only those heating elements identified in power queue 308. In an embodiment, the power queue 308 is connected to the power matrix 306.

Based on the sensor data and the respective element information, the power queue 308 dynamically prioritizes which surface receives power first, ensuring essential areas are addressed promptly.

The power queue 308 schedules power distribution to various surfaces, ensuring optimal power delivery at appropriate times.

The power queue 308 provides feedback loop integration by operating with sensors and feedback loops. The power queue 308 may adjust the power distribution sequence based on current conditions, such as increasing frost or reduced visibility or safety.

The power queue 308 manages power distribution both sequentially (one after another) or in parallel (multiple surfaces at once) with varied intensities.

The system includes a power converter 312. The power converter 312 is controlled by the controller 304. The power converter 312 receives electrical power from a power source 322. The power converter 312 directs the electrical power to the heating elements identified in the power queue 308 with a specific heating pattern and power run time.

In an embodiment, the determination of the specific heating pattern and the corresponding run time for each heating element is governed by safety and two principal categories of parameters. The first category includes the intrinsic characteristics of the element to be heated. The intrinsic characteristics include, but are not limited to, the element's size, shape, constituent materials, and curvature. The second category includes the prevailing operating conditions, such as ambient temperature, relative humidity in the surrounding environment, and predetermined maximum temperature settings for the heating element. The power converter 312, under the directive control of the controller 304, utilizes these parameters to determine and deliver the distribution and duration of electrical power to the heating elements, as identified in the power queue 308, ensuring an optimized heating process tailored to the specific requirements of each individual element and the environmental conditions.

The power converter 312 converts the electrical power received from the power source 322 to a specific pulsed power voltage for the respective heating element.

The power converter 312 may convert voltage levels, by either stepping them up or stepping them down based on the needs of the target surface or heating element. The power converter 312 may adjust and stabilize the current delivered to different surfaces, ensuring consistent and optimal heating.

The power converter 312 converts the type of current, transforming AC (alternating current) to DC (direct current) or vice versa, depending on the needs of the heating elements.

The power converter 312 alters the electrical frequency of pulsed power.

The power converter 312 regulates power delivery to ensure minimal energy wastage, optimizing the system's energy efficiency.

The power converter 312 provides pulsed electrothermal deicing (PETD) current to the heating elements 314, 316, 318, and 320 to provide heat to the target surface (not shown) for defrosting and defogging.

The power converter 312 may be implemented in various forms to suit specific applications or automobiles. The implementations include single DC power switches, single AC power switches with straight conversion capabilities. Additionally, more complex configurations like any one or more of DC-DC, AC-DC, DC-AC, and AC-AC power converters may be implemented. The implementations provide a range of conversion possibilities to adapt to specific power requirements of vehicles, airplanes, or other appliances.

Furthermore, the power converter may be integrated into existing systems within the vehicle or appliance, optimizing resource utilization. The integration may be achieved either by fully repurposing or modifying existing power converters within the vehicle or appliance, or by partially modifying them. In an embodiment, the onboard charger is modified to operate as a power converter for the present device and system. The existing power converters within the vehicle or appliance may be partially modified including by providing power factor correction to perform as the power converter 312 of the present device and system.

The power source 322 provides electrical power to the low-energy multi-surface heating system. The power source 322 is the vehicle's power storage component such as batteries. The power source 322 comprises a built-in energy storage mechanism such as batteries or capacitors. These storage units may be charged and discharged, providing power when needed. The power source 322 may deliver variable voltage and current outputs, adapting to the configuration of the power converter 312.

The power source 322 includes a plurality of output ports, each possibly delivering different voltage and power durations. The power converter 312 is connected to a plurality of power sources 322 with different voltage levels. A plurality of power sources 322 are used for specific heating elements based on the element design. The controller 304 is connected to multiple power converters 312 where each power converter is connected to a different power source 322.

The power converter 312 may be replaced with a DC switch and power, or used in conjunction with a DC switch and power for some or all of the heating elements. The DC switch and power may be used to provide or interrupt the path for direct voltage or current to the connected load or equivalent (e.g. another converter). The connected load includes the heating element. The DC switch and power provide the capability of supplying or blocking both current and voltage in all directions. The aim is to provide a high or low-voltage interruption or supply for bi-directional DC circuits to control the amount of power supplied to its connected load to protect it from surge or excessive inrush power. The time at which such a switch may be transitioning from a fully ON status to a fully OFF status or vice versa is designed to satisfy the connected load and achieve its power protection/regulation objective. Moreover, such a DC switch may transit from a fully ON status to a fully OFF (or vice versa) state in a rise or fall time that is significantly lower than its conduction time. Alternatively, the DC Switch may have a gradual linear or nonlinear transition with a fixed or controllable slope. The DC switch may be implemented by means of a mechanically operated switch, either manually or automatically operated, by a controlling signal such as DC or AC, or high or low voltage/current level. The DC Switch may also be implemented by means of a single or combination of electronic switches such as back-to-back monolithic unidirectional power switches, or monolithic bi-directional power switches. A similar function may be achieved by controlling the output voltage/current or a multiport DC-DC, or AC-DC converter.

The system 300 includes a plurality of heating elements 313, 316, 318, and 320.

Each heating element is connected to a target surface (not shown) for providing defogging and defrosting functions by means of resistive heating. The target surface may include vehicle windshields, rear windows, door handles, or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems.

The heating element includes optically transparent electrically-conductive coating (OTEC) material placed on the target surface, such as a windshield. However, all elements within the system may not be equipped with OTEC material, depending upon the specific nature and function of each heating element. The optically transparent electrically conductive coating (OTEC) material may be placed at the inner cross-section layer of the target surface. The optically-transparent electrically-conductive coating (OTEC) material includes a coating or a film, when applied to the target surface, allows electricity to pass through, at least a section, of the coating on the target surface. The coating, when applied to the target surface, allows the visible light to completely pass through the target surface. The coating, when applied to the target surface, allows the light to pass, at least partially, through the target surface.

The heating elements 314, 316, 318, and 320 include electrical connectors (not shown) that are connected to the target surface to apply the electric current to the coating on the target surface. The connectors are connected to the target surface through respective busbars (not shown).

The electric current is supplied to the electrically conductive coating of the heating element by the first busbar. The first busbar is electrically connected to the power converter 312. The first busbar may be composed of either a metallic aluminum or copper strip or silver paste. The first busbar receives electrical current from the power converter 312 and distributes the electrical current into the target surface through the coating of the heating element. As the electrical power traverses through the conductive material of the coating, heat is generated due to the resistivity of the electrically conductive coating, resulting in the deicing of, at least a section, of the accumulated ice or fog on the target surface. In an embodiment, a similar application of heat on the other target surfaces results in defogging or defrosting of, at least a section of, the fog collected on the other target surfaces. The current returns to the power converter 312 through the second busbar connected to the second connector to complete the circuit.

In an embodiment, an alternative electrical current receiving unit is utilized instead of the busbars.

Each of the multiple surfaces for heating is connected to at least one sensor for closed feedback control for the energy and time optimization. In an embodiment, a plurality of sensors are provided configured to facilitate precise feedback control. The sensors include temperature sensors, encompassing both contact-based (such as thermocouples) and non-contact types (such as infrared sensors). Further, the sensors include humidity sensors configured for monitoring ambient moisture levels. Additionally, the system's capabilities are optimized by ultrasonic, piezoelectric, and capacitive sensors, which are configured for detecting ice formation. Further, the plurality of sensors include speed sensors to optimize the system's performance based on vehicular dynamics or other relevant speed-related parameters.

In an embodiment, the sensors are configured to provide crash detection and protection operations. The sensors may include piezoelectric sensors for pedestrian crash protection. The sensors may detect potential collisions with pedestrians and activate preventive measures. The sensors may provide crash prevention by effecting control over crucial systems like the ignition or immobilizer, thereby enhancing overall vehicular safety.

By providing the heating control and regulation by means of closed feedback control provided by the sensor, the glass temperature may be maintained above the level where moisture accumulates, thereby enhancing the comfort inside the cabin. Moisture-free includes keeping a surface above 0° C. such that the surface is frost-free and at a controlled temperature around the dew point thus making it free from condensation and fog. The system may also be configured to keep the glass temperature higher to provide a heat shield, thereby reducing the loss of heat through window surfaces. In an embodiment, the higher temperature includes pulsating heat. This mode is quantitatively defined by a calculated ratio based on the relationship between the average temperature and the peak-to-peak temperature variation. As a result, a precise understanding and control of the thermal output is provided, ensuring that the system maintains an optimized temperature profile, particularly beneficial for applications requiring enhanced heat retention or shielding properties. In an embodiment, the defrosting temperature is higher than the defogging temperature. Preferably, the temperature is set to maximize the passenger comfort while minimizing cabin heat from the HVAC. This can improve a passenger's feeling of comfort, especially when the passenger's head, neck, or shoulders are close to a window surface. While creating a heat shield via heated windows around the passenger will increase the passenger's feeling of comfort, it may also lower the heating load on the HVAC heating system thereby conserving energy, especially in cold temperatures when power consumption for heating purposes is higher than normal. Overall, this may improve the driving range for electric vehicles.

The type of heat shield may be created using multiple combinations of windows depending on the outside temperature and number of passengers. The heat shield may be created by heating just a single window surface or any combination of window surfaces to reduce heat loss closest to the passenger(s) in the vehicle at that time.

A plurality of sensors (not shown) are connected to each heating element or the respective surface.

The plurality of sensors includes temperature sensors to measure the exact temperature of the surface to determine whether it is below freezing.

The plurality of sensors includes humidity sensors to detect moisture levels, which can indicate the formation or potential for fog or frost.

The plurality of sensors include impedance sensors to measure the electrical impedance of the surface, which can vary based on moisture or frost presence.

The plurality of sensors includes optical sensors to detect visible obstructions like frost, fog, or ice on the surface.

The multiple heating surfaces connected to the system may use multiple types of conductive materials. The conductive materials on different heating surfaces may comprise a different level of sheet resistance, measured in Ohms per square. Since each heated surface will have a different surface area, the heating intensity may be optimized by selecting the appropriate conducting materials for coating, selecting the surface area for coating, selecting the bus bar location, and tuning the resistance levels to achieve a target resistance level. In an embodiment, the resistance across the various heating surfaces within the system is established to attain a predefined power output, ranging from a minimum of 4 kilowatts per square meter to a maximum that may reach up to 15 kilowatts per square meter. This resistance level is contingent upon the available voltage levels within the vehicle, which predominantly encompass high-voltage systems but may also include low-voltage configurations. The Ohm's Law, denoted as V=I*R, is referred to during this process, ensuring that the current (I) and resistance (R) are appropriately adjusted to align with the voltage (V) parameters of the vehicle's electrical system. In an embodiment, the determination of resistance within the system's heating surfaces is based on achieving a specific power-per-area target. The target is defined by the desired thermal output relative to the surface area of each individual heating element, ensuring optimal energy distribution in accordance with the system's design parameters.

Overall, the heating intensity shall be optimized to enable a similar power level delivered to each surface with the minimal amount of energy to keep it moisture-free of frost and fog. The wider range of resistance (R) allows application of a wider range of the voltage (V), that can be utilized for enabling the attainment of optimal power and thereby enhancing the thermal efficiency of the system.

The low-energy multiple-surface heating system provides heating to at least one element of the multiple heating elements connected to respective surfaces. The heating elements may be of different sizes, materials, and conductive coating, and possess different physical, mechanical, or electrical properties. One embodiment includes a windshield, composed of glass incorporating an Optically Transparent Electrically-Conductive (OTEC) layer, typically silver-based, covering the windshield's entire dimension. The windshield dimension is approximately 0.7 meters by 1.4 meters for passenger vehicles. Another example includes an ADAS surface, potentially prepared from polycarbonate, employing an alternative coating, such as Carbon Nanotubes (CNT), over a significantly smaller area, spanning only a few centimeters in each dimension.

The controller 304 calculates the respective parameters for each element based on the respective element information. The respective element information includes element size, element material, and the element's physical, mechanical, or electrical properties. The respective element information includes Sensor Data 310. The Sensor Data 310 includes impedance measurement and temperature measurement. By dynamically selecting the power level and duration based on the respective element information, the controller reduces energy consumption by activating heating elements in the power queue 308 and providing a specific heating pattern and run time.

The controller 304 is configured to execute pre-determined heating patterns including the time and voltage to implement the heating patterns. Further, the controller 304 may be configured to collect the capacitance value of target surfaces from the sensors and sensor data 310 to determine the volume of accumulated ice on the sections.

The heating pattern and run-time are customized to each heating element based on the respective element information.

Some heating elements may need a single pulse of heat or multiple pulses of heat with a specific fixed or variable frequency and amplitude to remove the accumulated frost or fog.

Some heating elements may have a ramp-up at the beginning of the power applications to avoid any thermal shock to the element that can create thermal stress and reduce long term durability.

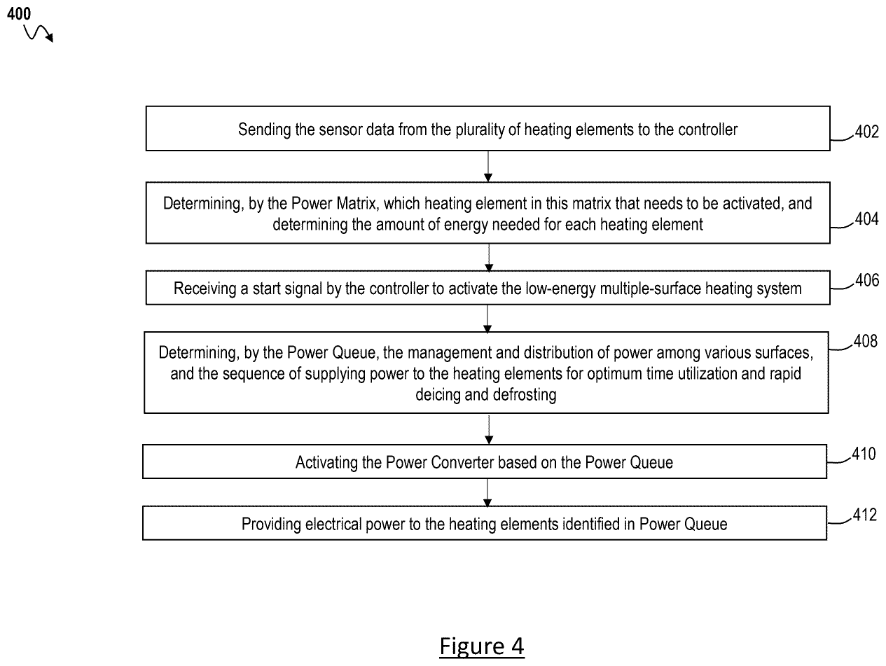

FIG. 4 shows a flow chart of a method 400 for low-energy multiple-surface heating, according to an embodiment.

The method 400 may be integrated to heat multiple surfaces in passenger vehicles, commercial trucks, airplanes, ships, trains, or other vehicles. The system may also be integrated to heat multiple surfaces in refrigeration equipment. Examples of the surfaces that may be heated for defrosting and defogging include but are not limited to, windshields, glass, side windows, rear windows, top windows (sunroof or panoramic roof), ADAS surfaces (cameras, or LiDAR), headlamps, the Outside Heat Exchanger, brakes, evaporator heat exchangers, and others.

Pulsed high-power heating systems are efficient in keeping surfaces clear of moisture such as ice, frost, or fog condensation, while minimizing energy consumption and time duration for running those systems. High power includes short bursts or pulses of energy instead of continuous power.

The low-energy multiple-surface heating method 400 comprises providing pulsed electrical power to multiple surfaces for resistive heating. During the pauses between pulses at one surface, the method 400 provides for directing similar high-power electricity to another surface, thereby providing resistive heating to the other surface.

When applied to a refrigeration system, the system provides high-power heating and defrosting to multiple heat exchangers by rotating the power to each heat exchanger.

At 402, the start signal is sent to the controller to activate the low-energy multiple-surface heating system.

In an automobile, the start signal may be initiated by a start switch. The start switch may include a manual or automatic switch such as a dashboard button, or a touchscreen interface allowing the driver to tap on a designated icon to activate the system, a voice activation interface leveraging voice recognition technologies, or an automatic sensing device to auto-initiate the system when specific conditions are detected, such as a certain drop in temperature or noticeable frost buildup. The automatic initiation is based on the detection condition such as the detection of ice, frost, or fog on the surface or a temperature threshold. The detection condition or threshold could be customized for each heating element.

At 404, the controller on receiving a start signal manages the power matrix (list of all elements) and determines which heating element in this matrix needs to be activated.

In various embodiments, the heating elements may include at least one of embedded wires, patterned conductive elements, or other conductive elements.

404 includes governing the sequence and duration of the pulsed electrical power by means of a timed switch, programmed by an algorithm. Upon activation, the timed switch may direct the first pulse of electrical power to the initial surface. Once this pulse concludes, the timed switch, based on the timed sequence, then redirects the subsequent pulse to the second surface. This sequence persists, with each surface receiving its designated pulse, ensuring every surface is adequately addressed without any continuous electrical supply to any individual surface. This systematic, sequential approach ensures each surface gets an optimal amount of heat for defrosting while maintaining energy efficiency and minimizing potential wear on any single surface.

By using a timed switching means in an electric vehicle, the pulsed electrical power may be provided to the windshield as the first part of the sequence; thereafter, the pulsed electrical power may be provided to the front side windows as the second part of the sequence; thereafter, the pulsed electrical power may be provided to the rear seat side windows as the third part of the sequence; thereafter, the pulsed electrical power may be provided to the rear window as the fourth part of the sequence; thereafter, the pulsed electrical power may be provided to the ADAS surfaces (e.g., Camera, LiDAR, etc.) as the fifth part of the sequence; thereafter, the pulsed electrical power may be provided to the headlamp surfaces as the sixth part of the sequence; thereafter, the pulsed electrical power may be provided to the brakes as the seventh part of the sequence; and thereafter, the pulsed electrical power may be provided to the Outside Heat Exchanger (Heat Pump System) as eighth part of the sequence.

404 includes rotating the supply of pulsed electrical power to heating elements, wherein at least one element is connected to a target surface. The target surface may include the windshield, handles, rear windows, etc. of a vehicle.

At 406, the sensor data from the plurality of the heating elements are sent to the controller.

406 includes continuously monitoring the state of each target surface and corresponding heating element using sensor data and respective element information to determine the real-time objectives for heating.

406 includes depending on the sensed condition, adapting the power pulse frequency and duration to ensure optimal defrosting and defogging without wastage of energy.

406 includes adjusting energy distribution to ensure the most efficient use of available power and optimizing for energy conservation.

406 includes prioritizing the direction of pulsed power to a specific heating element in the plurality of heating elements for prioritized frost or fog removal. For example, the user might prioritize the removal of frost from the windscreen before the frost removal from the rear windows. The controller may allow users to manually set preferences, such as specific temperature thresholds for each surface.

At 408, the power queue is determined to manage the distribution of power among various surfaces.

The identifiers of the heating elements that need activation are sent to power queue.

408 includes, based on the sensor data and the respective element information, dynamically prioritizing which surface receives power first, ensuring essential areas are addressed promptly.

408 includes calculating the respective parameters for each element based on the respective element information. The respective element information includes element size, element material, and the element's physical, mechanical, or electrical properties. The respective element information includes Sensor Data. The Sensor Data includes impedance measurement and temperature measurement. By dynamically selecting the power level and duration based on the respective element information, the controller reduces energy consumption by activating heating elements in the power queue and providing specific heating patterns and run times.

The multiple heating surfaces connected to the system may use multiple types of conductive materials. The conductive materials on different heating surfaces may comprise a different level of sheet resistance, measured in Ohms per square. Since each heated surface will have a different surface area, the heating intensity may be optimized by selecting the appropriate conducting materials for coating, selecting the surface area for coating, selecting the bus bar location, and tuning the resistance levels to achieve a target resistance level. Overall, the heating intensity may be optimized to enable a similar power level delivered to each surface with the minimal amount of energy to keep it moisture-free of frost and fog.

The low-energy multiple-surface heating system provides heating to at least one element of the multiple heating elements connected to respective surfaces. The heating elements may be of different sizes, materials, and conductive coating, and possess different physical, mechanical, or electrical properties.

At 410, the controller activates the power converter based on the power queue.

410 includes scheduling power distribution to various surfaces based on the power queue, ensuring optimal power delivery at appropriate times.

410 includes providing feedback loop integration by the power queue operating with sensors and feedback loops. The power queue may adjust the power distribution sequence based on current conditions, such as increasing frost or reduced visibility or safety.

410 includes managing power distribution both sequentially (one after another) or in parallel (multiple surfaces at once) with varied intensities by means of the power queue.

At 412, the power converter provides electrical power to the heating elements identified in power queue.

412 includes directing the electrical power to the heating elements identified in the Power 308 with a specific heating pattern and power run time.

412 includes converting the electrical power received from the power source to a specific pulsed power voltage for the respective heating element.

In some embodiments, 412 may include converting voltage levels, by either stepping them up or stepping them down based on the target surface or heating element. The power converter may adjust and stabilize the current delivered to different surfaces, ensuring consistent and optimal heating.

412 includes converting the type of current, including transforming AC (alternating current) to DC (direct current) or vice versa, depending on the configuration of the heating elements.

412 includes altering the electrical frequency of pulsed power.

412 includes regulating power delivery to ensure minimal energy wastage and optimizing the system's energy efficiency.

412 includes providing pulsed electrothermal deicing (PETD) current to the heating elements to provide heat to the target surface for defrosting and defogging.

The method is applied to a plurality of heating elements.

Each heating element is connected to a target surface for providing defogging and defrosting functions by means of resistive heating. The target surface may include vehicle windshields, rear windows, door handles, or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems.

The heating element includes optically transparent electrically-conductive coating (OTEC) material placed on the target surface, such as a windshield. The optically transparent electrically conductive coating (OTEC) material may be placed at the inner cross-section layer of the target surface. The optically-transparent electrically-conductive coating (OTEC) material includes a coating or a film, when applied to the target surface, allows electricity to pass through, at least a section, of the coating on the target surface. The coating, when applied to the target surface, allows the visible light to pass through the target surface. The coating, when applied to the target surface, allows the light to pass, at least partially, through the target surface.

By providing the heating control and regulation by means of closed feedback control provided by the sensor, the glass temperature may be maintained above the level where moisture accumulates, thereby enhancing the comfort inside the cabin. Moisture-free includes keeping a surface above 0° C. such that the surface is frost-free and at a controlled temperature around the dew point thus making it free from condensation and fog. The system may also be configured to keep the glass temperature higher to provide a heat shield, thereby reducing the loss of heat through window surfaces. This can improve a passenger's feeling of comfort, especially when the passenger's head, neck, or shoulders are close to a window surface. While creating a heat shield via heated windows around the passenger will increase the passenger's feeling of comfort, it may also lower the heating load on the HVAC heating system thereby conserving energy, especially in cold temperatures when power consumption for heating purposes is higher than normal. Overall, this may improve the driving range for electric vehicles.

The type of heat shield may be created using multiple combinations of windows depending on the outside temperature and number of passengers. The heat shield may be created by heating just a single window surface or any combination of window surfaces to reduce heat loss closest to the passenger(s) in the vehicle at that time. Advantageously, a single system connected to multiple heating elements and surfaces improves thermal efficiency while reducing energy use. As a result, the component count necessary for powering multiple surfaces is reduced, thereby enhancing overall system efficiency.

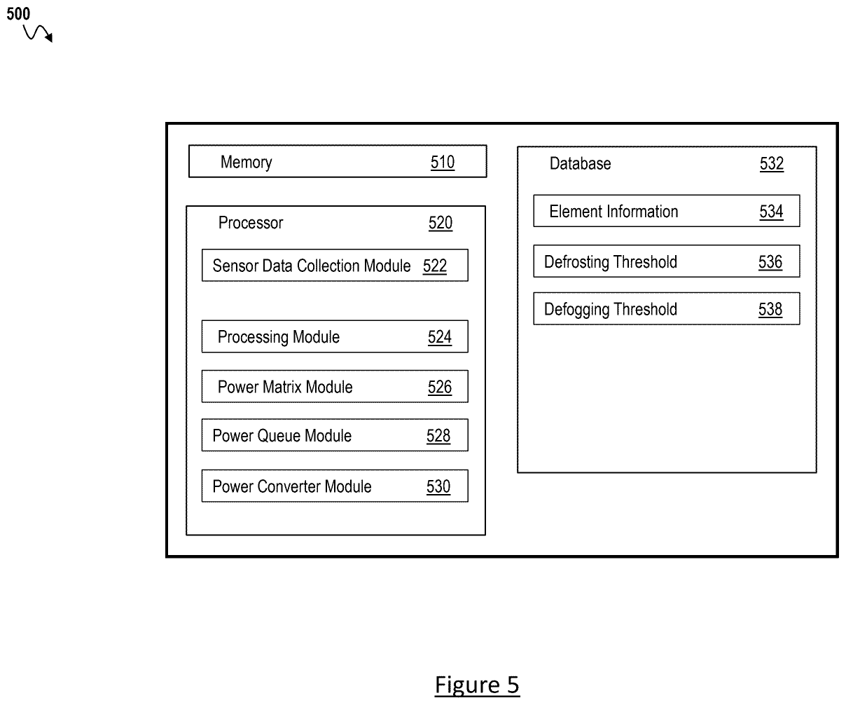

FIG. 5 is a block diagram of a controller 500 for multi-surface defogging and defrosting, according to an embodiment. The controller 500 may be controller 304 shown in FIG. 3.

The controller 500 includes a memory 510, processor 520, and database 532. According to other embodiments, the database 532 may be hosted by a separate server connected to the controller 500.

The controller 500 may be integrated to heat multiple surfaces in passenger vehicles, commercial trucks, airplanes, ships, trains, or other vehicles. The system may also be integrated to heat multiple surfaces in refrigeration equipment. Examples of the surfaces that may be heated for defrosting and defogging include but are not limited to, windshields, glass, side windows, rear windows, top windows (sunroof or panoramic roof), ADAS surfaces (cameras, or LiDAR), headlamps, the Outside Heat Exchanger, brakes, evaporator heat exchangers, and others.

Pulsed high-power heating systems are efficient in keeping surfaces clear of moisture such as ice, frost, or fog condensation, while minimizing energy consumption and time duration for running those systems. High power includes short bursts or pulses of energy instead of continuous power.

The low-energy multiple-surface controller 500 is configured to provide pulsed electrical power to multiple surfaces for resistive heating. During the pauses between pulses at one surface, the controller 500 directs similar high-power electricity to another surface, thereby providing resistive heating to the other surface.

When applied to a refrigeration system, the controller 500 provides high-power heating and defrosting to multiple heat exchangers by rotating the power to each heat exchanger.

The controller 500 includes a processing module 522. The processing module 522 is configured to activate the low-energy multiple-surface heating function on receiving the start signal.

The controller 500 includes a power matrix module 524. The power matrix module 524 is configured to, on receiving a start signal, manage the power matrix (list of all elements) and determine which heating element in this matrix needs to be activated.

The power matrix module 524 is configured to govern the sequence and duration of the pulsed electrical power by means of a timed switch, programmed by an algorithm. Upon activation, the timed switch may direct the first pulse of electrical power to the initial surface. Once this pulse concludes, the timed switch, based on the timed sequence, then redirects the subsequent pulse to the second surface. This sequence persists, with each surface receiving its designated pulse, ensuring every surface is adequately addressed without any continuous electrical supply to any individual surface. This systematic, sequential approach ensures each surface gets an optimal amount of heat for defrosting while maintaining energy efficiency and minimizing potential wear on any single surface.

By using a timed switching means in an electric vehicle, the pulsed electrical power is provided to the windshield as the first part of the sequence; thereafter, the pulsed electrical power may be provided to the front side windows as the second part of the sequence; thereafter, the pulsed electrical power may be provided to the rear seat side windows as the third part of the sequence; thereafter, the pulsed electrical power may be provided to the rear window as the fourth part of the sequence; thereafter, the pulsed electrical power may be provided to the ADAS surfaces (e.g., Camera, LiDAR, etc.) as the fifth part of the sequence; thereafter, the pulsed electrical power may be provided to the headlamp surfaces as the sixth part of the sequence; thereafter, the pulsed electrical power may be provided to the brakes as the seventh part of the sequence; and thereafter, the pulsed electrical power may be provided to the Outside Heat Exchanger (Heat Pump System) as eighth part of the sequence.

The power matrix module 524 is configured to rotate the supply of pulsed electrical power to heating elements, wherein at least one element is connected to a target surface. The target surface may include the windshield, handles, rear windows, etc. of a vehicle.

The controller 500 includes a sensor data collection module 522. The sensor data collection module 522 is configured to receive the sensor data from the plurality of heating elements.

Sensor data collection module 522 is configured to continuously monitor the state of each target surface and corresponding heating element using sensor data and respective element information to determine the real-time use for heating.

Sensor data collection module 522 is configured to, depending on the sensed condition, adapt the power pulse frequency and duration to ensure optimal defrosting and defogging without wastage of energy.

Sensor data collection module 522 is configured to, adjust energy distribution to ensure the most efficient use of available power, optimizing for energy conservation.

Sensor data collection module 522 is configured to prioritize the direction of pulsed power to a specific heating element in the plurality of heating elements for prioritized frost or fog removal. For example, the user might prioritize the removal of frost from the windscreen before the frost removal from the rear windows. The controller may allow users to manually set preferences, such as specific temperature thresholds for each surface.

The controller 500 includes a power queue module 528. The power queue module 528 is configured to determine the power queue to manage the distribution of power among various surfaces.

The identifiers of the heating elements that need activation are sent to power queue.

The power queue module 528 is configured to, based on the sensor data and the respective element information, dynamically prioritize which surface receives power first, ensuring essential areas are addressed promptly.

The power queue module 528 is configured to calculate the respective parameters for each element based on the respective element information. The respective element information includes element size, element material, and the element's physical, mechanical, or electrical properties. The respective element information includes Sensor Data. The Sensor Data includes impedance measurement and temperature measurement. By dynamically selecting the power level and duration based on the respective element information, the controller reduces energy consumption by activating heating elements in the power queue and providing specific heating patterns and run times.

The multiple heating surfaces connected to the system may use multiple types of conductive materials. The conductive materials on different heating surfaces may comprise a different level of sheet resistance, measured in Ohms per square. Since each heated surface will have a different surface area, the heating intensity may be optimized by selecting the appropriate conducting materials for coating, selecting the surface area for coating, selecting the bus bar location, and tuning the resistance levels to achieve a target resistance level. Overall, the heating intensity shall be optimized to enable a similar power level delivered to each surface with the minimal amount of energy to keep it moisture-free of frost and fog.

The low-energy multiple-surface heating system provides heating to at least one element of the multiple heating elements connected to respective surfaces. The heating elements may be of different sizes, materials, and conductive coating, and possess different physical, mechanical, or electrical properties.

The controller 500 includes a power converter module 530. The power converter module 530 is configured to activate the power converter based on the power queue.

The power converter module 530 is configured to schedule power distribution to various surfaces based on the power queue, ensuring optimal power delivery at appropriate times.

The power converter module 530 is configured to provide feedback loop integration by the power queue operating with sensors and feedback loops. The power queue may adjust the power distribution sequence based on current conditions, such as increasing frost or reduced visibility.

The power converter module 530 is configured to manage power distribution both sequentially (one after another) or in parallel (multiple surfaces at once) with varied intensities by means of the power queue.

The power converter module 530 is configured to provide electrical power to the heating elements identified in power queue.

The power converter module 530 is configured to direct the electrical power to the heating elements identified in the Power 308 with a specific heating pattern and power run time.

The power converter module 530 is configured to convert the electrical power received from the power source to a specific pulsed power voltage for the respective heating element.

In some embodiments, the power converter module 530 is configured to convert voltage levels, by either stepping them up or stepping them down based on the target surface or heating element. The power converter may adjust and stabilize the current delivered to different surfaces, ensuring consistent and optimal heating.

The power converter module 530 is configured to convert the type of current, including transforming AC (alternating current) to DC (direct current) or vice versa, depending on the configuration of the heating elements.

The power converter module 530 is configured to alter the electrical frequency of pulsed power.

The power converter module 530 is configured to regulate power delivery to ensure minimal energy wastage, optimizing the system's energy efficiency.

The power converter module 530 is configured to provide pulsed electrothermal deicing (PETD) current to the heating elements to provide heat to the target surface for defrosting and defogging.

The method is applied to a plurality of heating elements.

Each heating element is connected to a target surface for providing defogging and defrosting functions by means of resistive heating. The target surface may include vehicle windshields, rear windows, door handles, or other surfaces, vehicles including automobiles, electric vehicles, trains, and maritime vehicles; aircraft windshields, wings, rotors; building windows; outdoor equipment such as security cameras, lighting fixtures, electronic billboards, traffic signals; and evaporator coils in refrigeration and air conditioning systems.

The heating element includes optically transparent electrically-conductive coating (OTEC) material placed on the target surface, such as a windshield. The optically transparent electrically conductive coating (OTEC) material may be placed at the inner cross-section layer of the target surface. The optically-transparent electrically-conductive coating (OTEC) material includes a coating or a film, when applied to the target surface, allows electricity to pass through, at least a section, of the coating on the target surface. The coating, when applied to the target surface, allows the visible light to pass through the target surface. The coating, when applied to the target surface, allows the light to pass, at least partially, through the target surface.

By providing the heating control and regulation by means of closed feedback control provided by the sensor, the glass temperature may be maintained above the level where moisture accumulates, thereby enhancing the comfort inside the cabin. Moisture free includes keeping a surface above 0° C. such that the surface is frost-free and at a controlled temperature around the dew point thus making it free from condensation and fog. The system may also be configured to keep the glass temperature higher to provide a heat shield, thereby reducing the loss of heat through window surfaces. This can improve a passenger's feeling of comfort, especially when the passenger's head, neck, or shoulders are close to a window surface. While creating a heat shield via heated windows around the passenger will increase the passenger's feeling of comfort, it may also lower the heating load on the HVAC heating system thereby conserving energy, especially in cold temperatures when power consumption for heating purposes is higher than normal. Overall, this may improve the driving range for electric vehicles.

The type of heat shield may be created using multiple combinations of windows depending on the outside temperature and number of passengers. The heat shield may be created by heating just a single window surface or any combination of window surfaces to reduce heat loss closest to the passenger(s) in the vehicle at that time.

The database 532 includes heating element information 534. The respective element information includes element size, element material, and the element's physical, mechanical, or electrical properties. The respective element information includes Sensor Data. The Sensor Data includes impedance measurement and temperature measurement. By dynamically selecting the power level and duration based on the respective element information, the controller reduces energy consumption by activating heating elements in the power queue 308 and providing a specific heating pattern and run time.

The database 532 includes Defrosting Threshold 536. The Defrosting Threshold 536 includes a predefined temperature or condition at which the device activates its defrosting mechanism. This threshold is determined based on the temperature or moisture level where frost or ice begins to form or impacts visibility or functionality. For instance, the threshold might be set slightly above 0° C. (the freezing point of water) to ensure that surfaces remain free of frost or ice. In addition to temperature, humidity levels could be considered, since higher humidity can lead to condensation and frosting even at temperatures slightly above freezing. The defrosting threshold value is useful for ensuring that the system operates efficiently, activating only when necessary to conserve energy, and ensuring the safety and comfort of the vehicle's occupants or the efficiency of equipment.

The database 532 includes Defogging Threshold 538. The Defogging Threshold 536 includes predefined conditions, primarily relating to humidity and temperature, under which the defogging system triggers its defogging mechanism. This threshold is often determined by recognizing the conditions where moisture starts to condense on surfaces, causing fogging. For example, the threshold might be set to activate defogging measures when relative humidity inside the vehicle or equipment reaches a certain percentage while the temperature is within a specific range. Fogging typically occurs when warm, moist air comes into contact with a colder surface, leading to condensation. By setting an appropriate defogging threshold, the system can proactively address visibility or functional concerns before they become problematic, ensuring optimal safety, comfort, and efficiency without unnecessary energy consumption.

While the above description provides examples of one or more apparatus, methods, or systems, it will be appreciated that other apparatus, methods, or systems may be within the scope of the claims as interpreted by one of skill in the art.

1. A system for temperature control on a plurality of surfaces, the system comprising:
a plurality of conductive elements connected to the plurality of surfaces;
a powering unit conductively connected to each of the plurality of conductive elements, the powering unit configured to heat each of the plurality of conductive elements; and
a controller unit connected to the powering unit, the controller unit configured to activate the powering unit for selective heating of each of the plurality of conductive elements,
wherein a plurality of conductive elements are controlled by a single controller unit for low energy defrosting and defogging.

2. The system of claim 1, wherein the plurality of conductive elements comprises of a plurality of material properties, the plurality of material properties including size, compositional material, electrical conductivity, electrical resistance, heat coefficient, and structural dimension.

3. The system of claim 2, wherein the controller unit is activated automatically based on detection of an ambient condition on the each of the plurality of conductive elements, wherein the ambient condition includes at least one of: ice, frost, fog, moisture, a relative humidity, and a temperature threshold.

4. The system of claim 3, wherein the system further includes a power queue unit, the power queue unit configured to identify the selective heating of each of the plurality of conductive elements based on the plurality of material properties and the ambient condition of each of the plurality of conductive elements.

5. The system of claim 4, wherein the plurality of conductive elements are connected to a plurality of corresponding sensors to detect ambient condition for the each of the plurality of conductive elements.

6. The system of claim 5, wherein the controller unit is connected to a sensor unit, wherein the sensor unit is configured to collect the detected ambient condition from the plurality of corresponding sensors.

7. The system of claim 1, wherein the powering unit includes a plurality of power sources corresponding to the each of the plurality of conductive elements.

8. A method for detecting and removing frozen accumulation from a plurality of surfaces, the method comprising:
sending a sensor data from a plurality of conductive elements to a powering unit;
determining, by a power matrix, a heating element in the power matrix required to be activated and determining an energy amount needed the heating element, wherein the heating element is connected to a respective conductive element designated for heating;
receiving a start signal by a controller to activate a low-energy multiple-surface heating system, wherein the plurality of conductive elements are connected to a plurality of surfaces, and a powering unit is conductively connected to each of the plurality of conductive elements;
determining, by a power queue, management and distribution of power among the plurality of conductive elements designated for heating and a sequence of supplying power to the heating element for optimum time utilization and rapid deicing and defrosting; and
activating a power converter based on the power queue, wherein the power queue is configured to activate power delivery to the conductive elements designated for heating.

9. The method of claim 8, wherein the plurality of conductive elements comprises of a plurality of material properties for adjusting a resistance according to a surface, the plurality of material properties including size, compositional material, electrical conductivity, electrical resistance, heat coefficient, and structural dimension.

10. The method of claim 9, wherein the powering unit is activated automatically based on detection of an ambient condition on the each of the plurality of conductive elements, wherein the ambient condition includes at least one of: ice, frost, fog, moisture, a relative humidity, and a temperature threshold.

11. The method of claim 10, wherein the method further comprises identifying the selective heating of each of the plurality of conductive elements based on the plurality of material properties and the ambient condition of each of the plurality of conductive elements.

12. The method of claim 11, wherein the plurality of conductive elements are connected to a plurality of corresponding sensors to detect ambient condition for the each of the plurality of conductive elements.

13. The method of claim 12, wherein the powering unit is connected to a sensor unit, wherein the sensor unit is configured to collect the detected ambient condition from the plurality of corresponding sensors.

14. The method of claim 8, wherein the powering unit includes a plurality of power sources corresponding to the each of the plurality of conductive elements.

15. A device for detecting and removing frozen accumulation from a plurality of surfaces, the device comprising:
a processing module configured to activate the low-energy multiple-surface heating function on receiving the start signal, wherein a plurality of conductive elements to the plurality of surfaces, and a powering unit is conductively connected to each of the plurality of conductive elements;
a power matrix module configured to manage the power matrix and determining which heating element in this matrix needs to be activated, wherein the power matrix includes conductive elements designated for heating;
a sensor data collection module configured to receive sending the sensor data from the plurality of conductive elements to the powering unit;
a power queue module configured to determine the power queue to manage the distribution of power among the conductive elements designated for heating; and
a power converter module configured to activate the power converter based on the power queue, wherein the power queue is configured to activate power delivery to the conductive elements designated for heating.

16. The device of claim 15, wherein the plurality of conductive elements comprises of a plurality of material properties, the plurality of material properties including size, compositional material, electrical conductivity, electrical resistance, heat coefficient, and structural dimension.

17. The device of claim 16, wherein the device is activated automatically based on detection of an ambient condition on the each of the plurality of conductive elements, wherein the ambient condition includes at least one of: ice, frost, fog, moisture, a relative humidity, and a temperature threshold.

18. The device of claim 17, wherein the plurality of conductive elements are connected to a plurality of corresponding sensors to detect ambient condition for the each of the plurality of conductive elements.

19. The device of claim 18, wherein the sensor data collection module is connected to a sensor unit, wherein the sensor unit is configured to collect the detect ambient condition from the plurality of corresponding sensors.

20. The device of claim 19, wherein the power converter module is connected to a plurality of power sources corresponding to the each of the plurality of conductive elements, and wherein the power converter includes a modified power converter of a target vehicle or appliance.
